(19) United States
(12) Patent Application Publication
(10) Pub. No.: US 2003/0051744 A1
(43) Pub. Date: Mar. 20, 2003

(54) Apparatus for cleaning and drying articles

(76) Inventor: Philip J. Sullivan, Seminole, FL (US)

Correspondence Address: SMITH & HOPEN PA, 15950 BAY VISTA DRIVE, SUITE 220, CLEARWATER, FL, 33760

(21) Appl. No.: 09/682,542

(22) Filed: Sep. 18, 2001

(51) Int. Cl. B08B 3/04

(52) U.S. Cl. 134/57 R; 134/80; 134/105; 134/111; 134/135

(57) ABSTRACT

An apparatus for cleaning molds for making optical lenses includes seven stations arranged in a circular array with a rotatably mounted central hub in the middle of them. Seven radial arms extend from the central hub, one for each station, and a workpiece holder depends from the radially outermost end of each arm and holds the molds as they travel from station to station. A drive motor lifts and lowers the central hub and hence the molds, an index motor rotates the molds from station to station, and an oscillation motor oscillates the workpiece holders when the molds are immersed in a cleaning solution or rinse water. The rinse water is filtered and circulated continuously. After a final rinse, the rinse water is drained slowly so that the surface tension of the water removes all water spots and the cleaned molds are delivered to a discharge station. The entire process is microprocessor controlled.

### BACKGROUND OF INVENTION

1. Field of the Invention

This invention relates, generally, to devices for cleaning articles. More particularly, it relates to an apparatus for cleaning molds of the type used in making optical lenses.

2. Description of the Prior Art

Optical molds are difficult to clean for several reasons. Monomers become polymerized, for example, during the lens curing process and such polymers may stick to the mold. The person attempting to scrub such polymers from the mold may succeed in doing so but may leave fingerprints on the mold. Even a skilled worker must expend a lot of hard work and a considerable amount of time to clean a mold. Where numerous molds must be cleaned every day, the work becomes onerous and the cleanliness of the molds begins to suffer as the day wears on. Cleaning by hand results in inconsistent quality and increases the probability of mold damage. Optical lenses made with dirty molds are unacceptable and must be discarded.

What is needed, then, is a machine that does the hard work of cleaning optical molds. The machine should be able to clean the last mold of the day with the same thoroughness as the first mold of the day, and every mold should exit the machine in a perfectly clean condition. The machine should be easy to operate, easy to maintain, and inexpensive.

However, in view of the prior art considered as a whole at the time the present invention was made, it was not obvious to those of ordinary skill in the pertinent art how such a machine could be provided.

### SUMMARY OF INVENTION

The longstanding but heretofore unfulfilled need for an apparatus that thoroughly and consistently cleans optical molds is now met by a new, useful, and nonobvious apparatus for cleaning and drying items. The novel structure includes a plurality of stations including a loading station adapted to receive items to be cleaned, a first cleaning station, a first rinse station, and a drying station arranged in circumferentially spaced apart relation to one another. A rotatably mounted central hub is positioned in encircled relation to the plurality of stations and a plurality of radially disposed arm members having respective radially innermost ends are connected to the central hub. A plurality of workpiece holders is provided. Each workpiece holder is adapted to hold an item to be cleaned and dried. Moreover, each workpiece holder is releasably secured to a radially outermost end of an associated arm member, and each workpiece holder depends from an associated radially outermost end of its associated arm member.

In a first embodiment, a plurality of cradle members are provided for holding the plurality of workpiece members. In a second embodiment, the cradle members are eliminated and each workpiece holder depends directly from its associated radial arm.

Indexing means are provided for effecting rotation of the central hub about a vertical axis in accordance with a predetermined program of operation. A microprocessor means controls the lifting and lowering of the radial arms and hence the workpiece holders and further controls the indexing means.

An important object of the invention is to provide a cleaning apparatus that is simple to operate so that its operation can be learned in less than an hour.

Additional important objects are to provide a machine that is easy to maintain, light-in-weight and thus easily moved, and ruggedly constructed with components that are chemically resistant and easy to clean.

Still further objects include the provision of a machine where all motion, heating, and pumping functions are under the control of a microprocessor. This ensures the reliability of the system. The programmability of the microprocessor allows the preset adjustments to be varied as may be required by differing applications.

Another object is to provide a machine equipped with overload sensors in communication with the microprocessor so that the microprocessor can shut down the machine in the event an overload condition is detected by the sensors.

Another object is to provide a substantially fully automated apparatus so that operator involvement in the cleaning process is minimal. Thus, with the exception of the manual loading of a loading station and the manual unloading of a discharge station, all functions of the machine are automatic, including all cleaning and drying functions.

Another object is to provide a machine having precise microprocessor-controlled temperature control and over-temperature protection.

Yet another object is to reduce wear and tear on the machine and to enable precise work positioning by providing “Slow Down” signals that slow the rotation of the central hub and its related parts as well as the ascent and descent of the sleeve prior to stopping of said hub, sleeve, and related parts.

Another object is to provide vigorous oscillation of the molds in the solvent/surfactant, and the rinse containers at the appropriate times of the cycle to enhance the cleaning effect of the system and reduce cycle time.

Still another object is to provide a simple, efficient method for drying the cleaned molds.

An object closely related to the foregoing object is to achieve spot free drying without employing elaborate methods, materials, and equipment.

These and other important objects, advantages, and features of the invention will become clear as this description proceeds.

The invention accordingly comprises the features of construction, combination of elements, and arrangement of parts that will be exemplified in the description set forth hereinafter and the scope of the invention will be indicated in the claims.

### BRIEF DESCRIPTION OF DRAWINGS

For a fuller understanding of the nature and objects of the invention, reference should be made to the following detailed description, taken in connection with the accompanying drawings, in which:

FIG. 1 is a perspective view of the novel apparatus;

FIG. 2 is a simplified top plan view of the apparatus when the top panel is removed;

FIG. 3A is a front elevational view thereof with the front panel removed and the lifting and lowering means in the “down” position;

FIG. 3B is a front elevational view as in FIG. 3A with the lifting and lowering means in the “up” position;

FIG. 4 is a side elevational view thereof with a side panel removed;

FIG. 5 is a simplified top plan view of the novel apparatus;

FIG. 6A is a plumbing diagram for the first solvent station;

FIG. 6B is a plumbing diagram for the second solvent station;

FIG. 6C is a plumbing diagram for the first rinse station;

FIG. 6D is a plumbing diagram for the second rinse station;

FIG. 6E is a plumbing diagram for the third rinse station; and

FIG. 7 is a high level flowchart disclosing the steps of the novel method.

### DETAILED DESCRIPTION

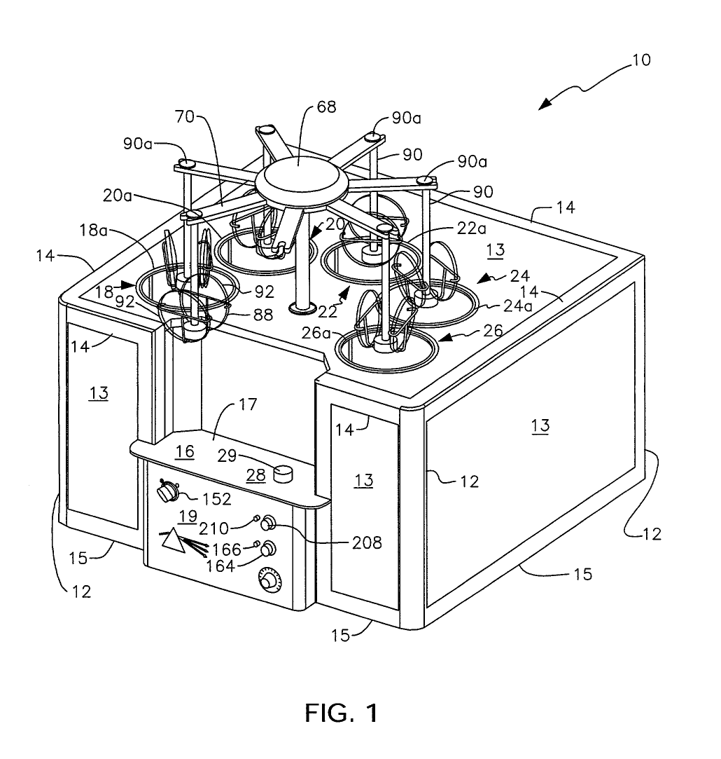

Referring now to FIG. 1, it will there be seen that the reference numeral 10 denotes an illustrative embodiment of the present invention as a whole.

Desktop cleaning machine 10 has a frame of generally parallelepiped construction. The frame includes four upstanding corner posts, collectively denoted 12. The posts are interconnected to one another at their respective uppermost ends by upper rails collectively denoted 14 and at their respective lowermost ends similar rails 15. Snap-on, removably mounted panels, collectively denoted 13, may be employed to close the back, sides, and front of the machine. The easy removability of such panels facilitates inspection and maintenance of the machine.

The operation of machine 10 is best explained by first providing a very broad overview of its primary parts and their respective functions. A more detailed look into the primary parts and the secondary or supporting parts of the machine will then be more easily understood.

In this preferred embodiment, machine 10 includes seven stations arranged in a generally circular pattern, i.e., the stations are circumferentially spaced with respect to one another. Station 16 is a loading station. In the illustrative embodiment of FIG. 1, station 16 occupies the left-hand side of a horizontal flat panel 17 that surmounts vertical face panel 19 of machine 10. The space above reference numeral 16 is a part of loading station 16. As will be described in greater detail hereinafter, the cleaning operation begins when a pair of molds 92, 92 to be cleaned are held in workpiece holder 88 and said workpiece holder 88 is releasably attached to a radial arm 70 disposed in juxtaposition with loading station 16 by a machine operator. Machine 10 carries the dirty molds in station 16 to a first cleaning station 18. The molds are there agitated in a heated solvent for a predetermined amount of time, which time is under the control of a microprocessor, and then transported to second cleaning station 20. The molds are again agitated in a heated solvent or perhaps in a heated surfactant or a solvent/surfactant mixture for said predetermined amount of time. The machine then carries the molds to a first rinsing station 22 where they are again agitated in clean rinse water. The molds are then carried to second rinsing station 24 where the rinsing process is performed a second time. The twice-rinsed molds are then carried to a rinsing/drying station 26 where said molds are rinsed in clean, heated rinse water.

The rinse water is then slowly drained under the influence of gravity at a controlled rate (preset at the factory but adjustable by the operator) from container 26a at station 26. The draining is slow enough to require a minute or two to completely drain said container 26a. This slow draining produces controlled rate drying which is a critical teaching of this invention. Controlled rate drying uses the surface energy of the rinse water itself to pull the water off the respective surfaces of the molds in a solid sheet. Uncontrolled draining results in patches of water breaking away from the main sheet or meniscus of the water that is held together by surface tension. Such patches remain on the mold surface and eventually dry into unacceptable water spots. Controlled rate drying, a method introduced by this disclosure, eliminates water spots and produces molds that are clean, dry, and unblemished

More particularly, the water in container 26a is heated to warm the molds. As dry, air-conditioned air contacts the molds as the heated rinse water drains from container 26a, any remaining traces of water are flash dried into a vapor state and leave the molds in a highly cleansed and dried condition. The machine then carries the clean and dry molds to discharge station 28 where the operator may remove them.

In a preferred embodiment, the cycle time is variable from one to thirty minutes, as determined by the operator, thus providing a large range of flexibility and enabling the cleaning of molds or other items of widely varying degrees of cleanliness.

Having completed a very broad overview of the machine, a more detailed look at the various parts thereof will now be undertaken.

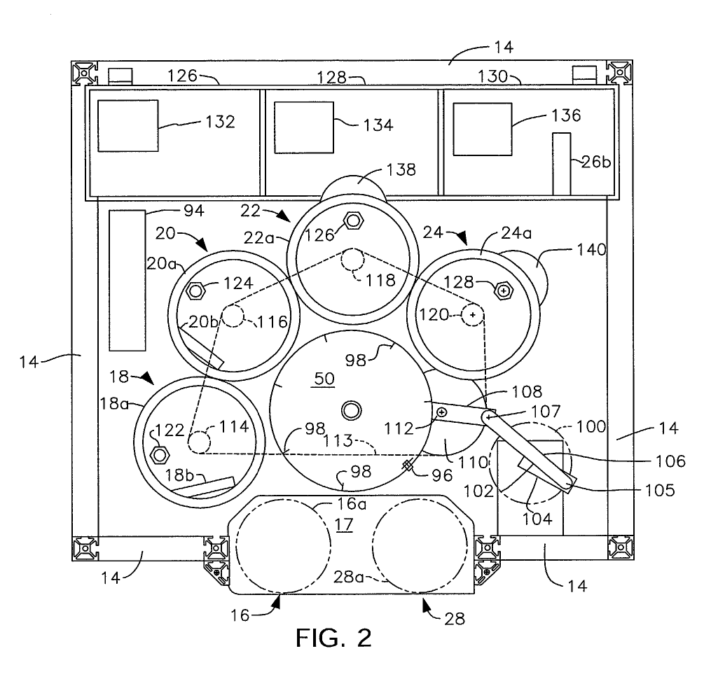

As perhaps best understood in connection with FIG. 2, an open-topped container 18a, 20a, 22a, 24a, and 26a of generally cylindrical construction is positioned at each station 18, 20, 22, 24, and 26 respectively. There are no containers at stations 16 and 28, but the boundaries of the respective spaces that form said stations are denoted in phantom lines and indicated by the reference numerals 16a and 18a.

Each container 18a, 20a, 22a, 24a, and 26a has a common predetermined depth. Thus, a lowering means is provided for lowering a pair of molds or other items to be cleaned into a container at the beginning of that station”s duty cycle, and a raising means is provided for lifting the items from the station at the completion of the station”s duty cycle. Due to the circular arrangement of stations, a revolving index means is provided to carry the molds in sequence from loading station 16, to first cleaning station 18, second cleaning station 20, first rinsing station 22, second rinsing station 24, third rinsing and drying station 26, and unloading station 28.

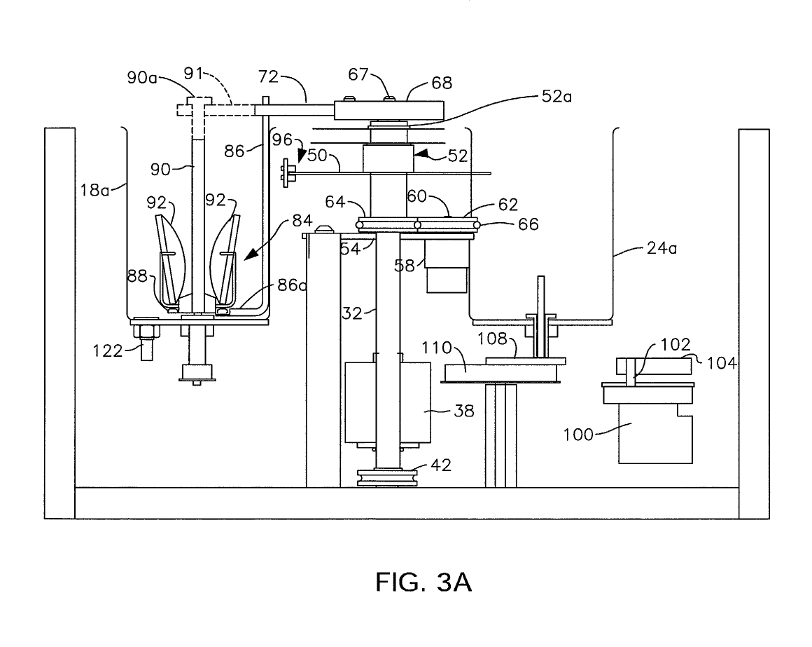

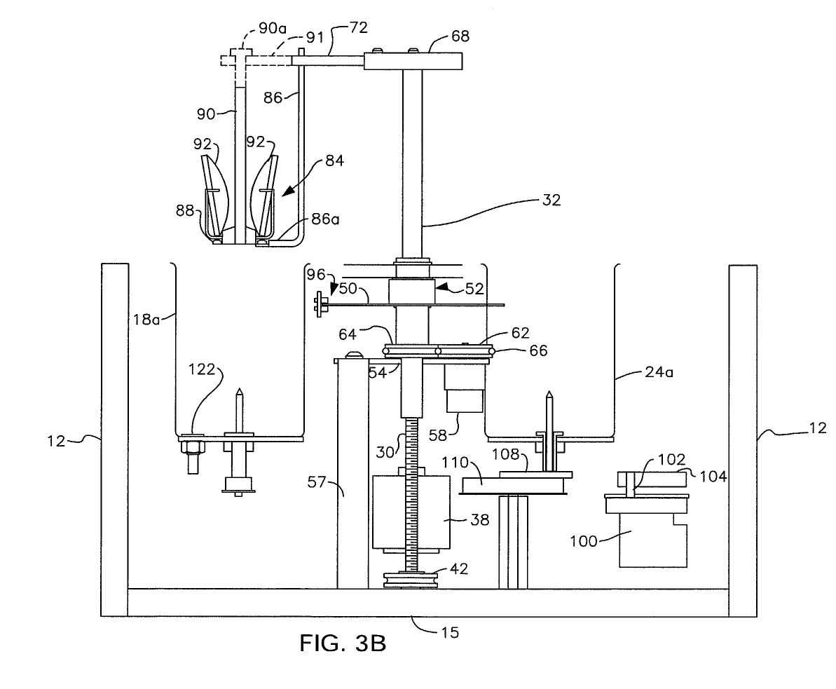

In this illustrative embodiment, as perhaps best depicted in FIGS. 3A and 3B, an upstanding externally threaded lead screw 30 is screwthreadedly engaged by an upstanding internally threaded sleeve 32. Accordingly, sleeve 32 travels upwardly or downwardly depending upon the direction of rotation of lead screw 30. The pitch of the threads of lead screw 30 is steep so that each rotation of the screw translates into substantial upward or downward travel of sleeve 32. FIG. 3A depicts sleeve 32 in its fully retracted/down configuration and FIG. 3B depicts said sleeve 32 when fully extended.

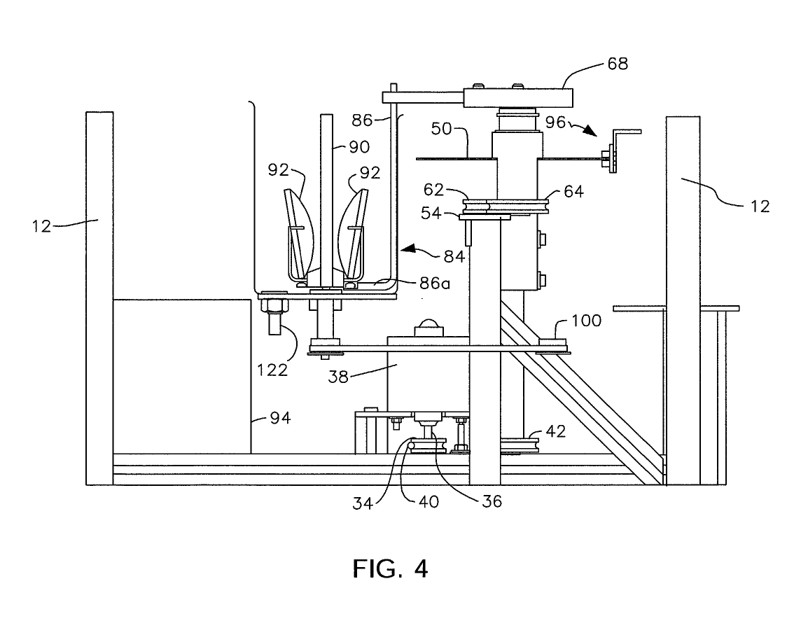

As depicted in FIG. 4, pulley 34 is mounted on output shaft 36 of drive motor 38 for conjoint rotation therewith. Drive belt 40 interconnects pulley 34 and pulley 42, said latter pulley being mounted to lead screw 30 at its lowermost end for conjoint rotation therewith. Drive motor 38 is a DC low voltage reversible motor under the control of the microprocessor. Rotation of output shaft 36 in a first direction thus raises sleeve 32 and rotation of said output shaft in a second direction lowers said sleeve. When sleeve 32 is in its fully raised or uppermost position, the molds or other items undergoing cleaning are lifted completely out of the cylindrical container at the corresponding station so that the revolving means hereinafter described can carry them to the next station. Upon arrival at the next station, the microprocessor then sends a signal to drive motor 38 so that it re-commences operation in an opposite direction to cause sleeve 32 to lower the molds into the cylindrical container of the next station.

When sleeve 32 approaches its lowermost position, a first limit switch, not shown, sends a signal to the microprocessor and the microprocessor sends a “Slow Down” signal to drive motor 38. Drive motor 38 slows down and lead screw 30 slows to an angular velocity that is less than half of its full angular velocity. When sleeve 32 is fully seated in its lowermost position, a second limit switch, not shown, sends a signal to the microprocessor and the microprocessor sends a “Stop” signal to drive motor 38. In this way, sleeve 32 does not slam abruptly down to its stop position. Coming to a full stop from a slower speed greatly improves vertical position accuracy and lengthens the lifespan of lead screw 30 and sleeve 32. It also prevents a strong vibration from rippling through the apparatus that could occur as a result of an abrupt lowering of sleeve 32. Such vibrations generated repeatedly throughout the day could eventually cause the machine to operate at less than optimal performance.

The revolving means for carrying the molds from station to station along a circular path of travel includes a horizontally disposed control disc 50 that has an axis of rotation coincident with, i.e., in axial alignment with, the axis of rotation of lead screw 30. Control disc 50 is positioned at a constant height and does not reciprocate upwardly and downwardly as does sleeve 32. Said control disc is centrally apertured so that sleeve 32 extends therethrough without contacting it. Housing assembly, denoted 52 as a whole in FIG. 2, provides support for control disc 50. Housing 52 is keyed to sleeve 32 and clamped to inner bearing 52a.

As indicated in FIG. 4, support post 56 is braced by channel member 57 which is disposed at about a 45° (forty five degree) angle. Channel member 57 is also depicted in FIG. 3A, in which view it conceals support post 56. Advantageously, many electrical wires may be grouped together within the hollow confines of channel member 57 to enhance the orderly appearance of machine 10.

Index motor 58 depends from support plate 54 as depicted in FIGS. 3A and 3B and has an output shaft 60 to which is secured driving pulley 62. Rotation of pulley 62 effects simultaneous rotation of driven pulley 64, said pulleys being interconnected by belt 66. Driven pulley 64 is attached for conjoint rotation to housing 52 which is keyed to sleeve 32 as aforesaid.

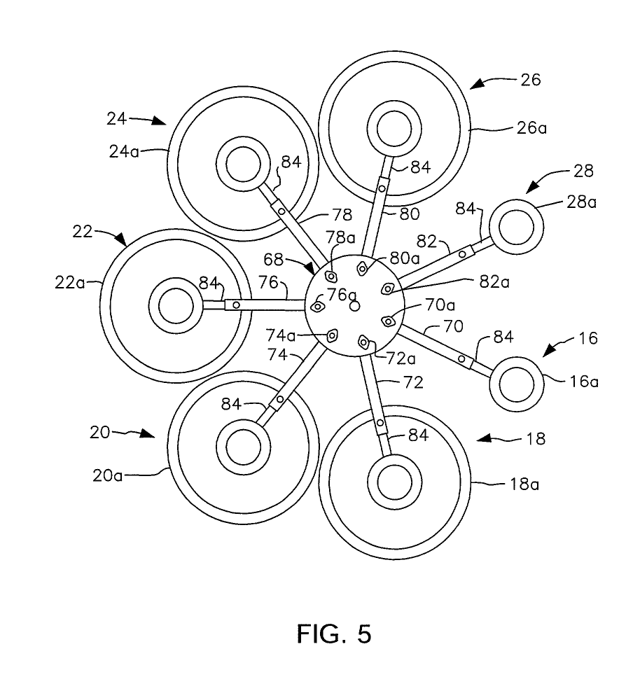

Central hub 68 (a circular, flat disc) is also attached to sleeve 32 for conjoint rotation therewith. Central hub 68 provides the mounting means for seven radially disposed arms, denoted 70, 72, 74, 76, 78, 80, and 82 in FIG. 5. Said arms are secured to central hub 68 at their respective radially innermost ends by screws 70a, 72a, 74a, 76, 78a, 80a, and 82a, respectively. Each of the respective radially outermost ends of said arms is adapted to engage an associated assembly, collectively denoted 84, for holding the molds.

In a first embodiment, as depicted in FIGS. 3A, 3B, and 4, each of these assemblies includes a generally “L”-shaped arm 86 that depends from the radially outermost end of its associated radially disposed arm. The vertical extent of each arm 86 extends downwardly into an associated container 18a, 20a, 22a, 24a, and 26a and similarly downwardly into loading and unloading stations 16 and 28. The horizontal part of each arm, collectively denoted 86a, supports a workpiece holder 88. In this embodiment, since there are seven work stations, there are seven workpiece holders, each of which is denoted 88 for convenience. Upstanding workpiece holder post 90 is an integral part of each workpiece holder 88 and enables a machine operator to manually position a workpiece holder 88 at loading station 16 so that workpiece holder 88 rests atop horizontal part 86a of lift arm 86, and to lift said workpiece holder 88 from discharge station 28 after the molds have been cleaned and dried.

In an alternative embodiment, depicted in phantom lines as at 91 in FIGS. 3A and 3B, vertical and horizontal lift arms 86 and 86a, respectively, are eliminated. Each radial arm 70, 72, 74, 76, 78, 80, and 82 is extended as depicted in said phantom lines 91 and a slot is formed in the outermost ends of each of said radial arms. Each workpiece holder post 90 has a head 90a larger than the slot that receives post 90 so that each workpiece holder 88 depends from its associated radial arm. The embodiment of FIG. 1 is this alternative embodiment.

Station 16 is the loading station and as is clear from FIG. 1, there is no container at said station. The machine operator manually loads workpiece holder 88 (holding molds 92, 92 or other items to be cleaned) into said station 16. The operator then pushes Start/Resume button 164 (FIG. 1) on face panel 19 of machine 10. Green indicator light 166 illuminates when said Start/Resume button has been activated. When the just-loaded molds have been carried to station 18, another workpiece holder 88 is loaded at loading station 16 and that operation is continued until all molds have been cleaned. After the operator has loaded a workpiece holder 88 at said loading station 16, the rest of the operation is automatic until a pair of fully cleaned and dried molds is automatically delivered to discharge station 28. The operator then removes workpiece holder 88 and the molds carried thereby from said discharge station.

When a workpiece holder 88 carrying a clean and dry pair of molds arrives at discharge station 28, the weight of the workpiece holder causes it to depress a button 29 at station 28. Button 29 is a switch actuator that sends a signal to the microprocessor. The microprocessor then sends a signal disabling further operation of the machine until such time as workpiece holder 88 is removed from discharge station 28. Upon removing said workpiece holder and the cleaned and dried molds supported thereby, the operator merely needs to place said molds at a preselected location. The operator then loads a workpiece holder 88 at loading station 16 carrying a pair of molds to be cleaned and presses Start/Resume button 164. Prior to pressing the Start/Resume button at the beginning of a work day, the machine operator fills first solvent container 18a with a suitable solvent and second solvent container 20a with a suitable solvent or surfactant or mixture thereof, as predetermined by the cleaning requirements of the jobs to be run. First rinse container 22a is filled with clean water, as is second rinse container 24a and third rinse/dry container 28a.

Activation of Start/Resume button 164 (which is preceded by turning power switch 152 from its Off to its On position) activates heater means 18b associated with first solvent container 18a, heater means 20b associated with second solvent container 20a, and heater means 26b associated with rinse/dry container 26a. Power for such heater means is supplied by an AC outlet. As the solvent warms up to a predetermined temperature, yellow light 210 on face panel 19 is caused to blink by a signal from the microprocessor means that controls all phases of the operation of the machine. The blinking yellow light is a signal to the operator that the solvent is not yet heated and that Start/Resume button 164 should not be pushed. The microprocessor may be programmed so that machine operation begins if the operator overrides the signal by pushing the Start/Resume button, or it may be programmed so that any pressing of the Start/Resume button prior to proper warming of the solvent is ineffective to start the machine.

Depending upon the programming of the microprocessor as aforesaid, pressing Start/Resume button 164 during or after heating of the solvent in containers 18a and 20a and the rinse water in rinse/dry container 26a, causes the mechanical parts of the machine to begin operation. The microprocessor sends a Start signal to drive motor 38 and rotation of lead screw 30 begins, which effects vertically upward travel of sleeve 32, central hub 68, radial arms 70, 72, 74, 76, 78, 80, and 82, and their associated workpiece holders, collectively denoted 88. When sleeve 32 reaches its uppermost limit, a limit switch, not shown, sends a signal to the microprocessor and the microprocessor sends a Stop signal to drive motor 38, thereby stopping rotation of lead screw 30 and thereby stopping the lifting of sleeve 32.

The microprocessor then sends a Start signal to index motor 58, thereby rotating sleeve 32, central hub 68, radial arms 70, 72, 74, 76, 78, 80, and 82 and hence each workpiece holder 88 until photoelectric cell 96 detects the leading edge of a notch 98 (FIG. 2) formed in control disc 50. Upon detection of said leading edge, photoelectric cell 96 (FIG. 3A) sends a “Leading Edge Detected” signal to the microprocessor which sends a “Slow Down” signal to index motor 58. Preferably, the motor speed drops to less than half its initial angular velocity. Slow indexing greatly improves the position accuracy of the indexing means. Control disc 50 continues its rotation but at the reduced angular velocity until photoelectric cell 96 detects the presence of the trailing edge of the notch and sends a “Trailing Edge Detected” signal to the microprocessor. Upon receipt of that signal, the microprocessor sends a “Stop” signal to index motor 58. When output shaft 60 of index motor 62 stops turning, each workpiece holder 88 is positioned directly above a loading station 16 or a container 18a, 20a, 22a, 24a, 26a, or discharge station 28, in alignment with the longitudinal axis of the corresponding station or container.

The microprocessor then sends a “Start” signal to drive motor 38 and sleeve 32 is lowered as lead screw 30 rotates in a direction opposite to its initial direction of rotation. This action lowers each cradle assembly 84 into the open container positioned below it.

When each container reaches a point near its lowermost position, the lowermost end of sleeve 30 trips a first limit switch, not shown, near a lowermost end of lead screw 30 and said first limit switch sends a signal to the microprocessor. The microprocessor, upon receipt of that signal, sends a “Slow Down” signal to drive motor 38 and the speed of said drive motor is reduced to less than half its normal speed.

When sleeve 32 reaches its lowermost position, its lowermost end trips a second limit switch, not shown, positioned at the lowermost end of lead screw 30 and said second limit switch sends a signal to the microprocessor which then sends a “Stop” signal to drive motor 38.

When drive motor 38 stops, each pair of molds immersed in solvent, surfactant, or rinse water is oscillated within its associated container for a predetermined amount of time to enhance the action of the solvent, the surfactant, or the rinse water. More specifically, each workpiece holder 88 is oscillated by an oscillation motor 100 (FIG. 2) having an output shaft 102 to which is keyed first link 104. A second link 106 has a first end pivotally mounted as at 105 to first link 104 near its radially outermost end and a second end pivotally mounted as at 107 to a radially outermost end of third link 108. The radially innermost end of third link 108 is secured to axis of rotation 112 of drive wheel 110 for conjoint rotation therewith in a horizontal plane. A continuous belt 113 follows a path of travel that includes the peripheral edge of drive pulley 110 as well as oscillation pulley 114 associated with first solvent container 18a, oscillation pulley 116 associated with second solvent/surfactant container 20a, oscillation pulley 118 associated with first rinse container 22a, and oscillation pulley 120 associated with second rinse container 24a. Microprocessor-controlled oscillation of output shaft 102 of oscillation motor 100 thus effects oscillation of belt 113 and hence of each oscillation pulley 114, 116, 118, and 120. Each oscillation pulley is in axial alignment with and is keyed to its associated workpiece post 90 of each workpiece holder 88.

The solvent in container 18a and the solvent or surfactant in container 20a will typically retain their efficacy throughout a work day. Accordingly, those containers are preferably drained at the end of a work day and recharged the following work day. The drain valves for said containers are denoted 122 and 124. A valved drain hose, not shown, is in fluid communication with each drain.

However, the rinse water in containers 22a, 24a, and 26a is continuously circulated through filters during the work day so that the rinse water remains very clean. Specifically, three circulation tanks 126, 128, and 130 are filled with clean rinse water at the beginning at each work day at the same time rinse containers 22a, 24a, and 26a are filled with clean water. Pumps 132, 134, and 136 continuously circulate the rinse water from tanks 126, 128, and 130, respectively, to said rinse containers 22a, 24a, and 26a through hoses dedicated to that function. The rinse water in said containers respectively flows over a weir means 138 (container 22a), 140 (container 24a), and 142 (container 26a) into said circulation tanks and said rinse water returns to said containers only after flowing through filter members that are positioned in said circulation tanks 126, 128, and 130, respectively.

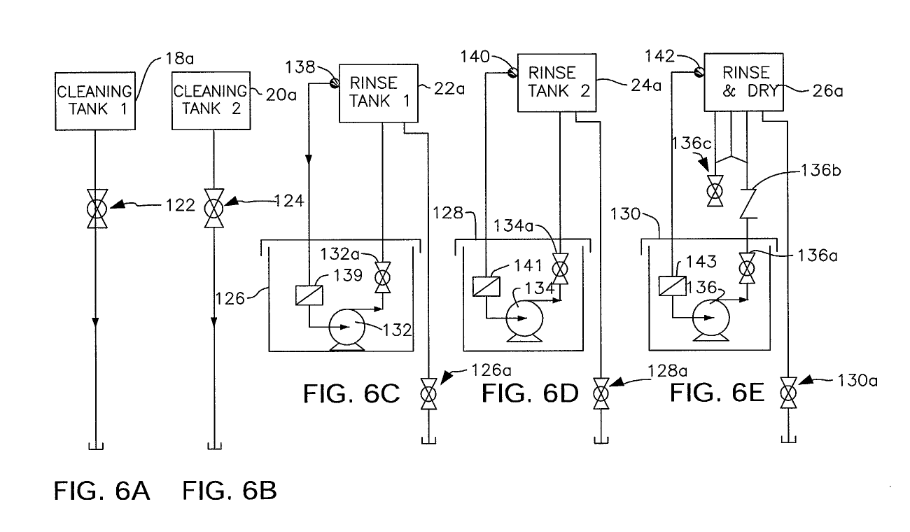

FIGS. 6A-E depict the plumbing system of the novel machine in diagrammatic form. As indicated in FIG. 6A, solvent container 18a is drained through manually-operated valve 122. Similarly, as indicated in FIG. 6B, solvent/surfactant container 20a is drained through manually-operated valve 124.

As indicated in FIG. 6C, rinse water from first rinse container 22a flows over weir 138, through filter 139, pump 132, valve 132a, and returns to first rinse container 22a. This circulation continues throughout a work day so that the rinse water is continually filtered before being returned to the first rinse container for re-use. At the end of a work day, or more frequently if needed, first rinse tank 22a is emptied through manually-operated valve 126a.

In the same way, as indicated in FIG. 6D, rinse water flows over weir 140, through filter 141, pump 134, valve 134a, and returns to second rinse container 24a. At the end of a work day, or more frequently if needed, second rinse container 24a is emptied through manually-operated valve 128a.

The plumbing for the third rinse/dry station 26 is depicted in FIG. 6E. Rinse water continuously flows over weir 142 of container 26a to remove air-borne or other contaminates floating atop the water, through filter 143, pump 136, valve 136a, and returns to container 26a through check valve 136b. The container is emptied as needed through manually-operated drain valve 130a. Valve 136c controls the drain rate; the drained water is routed back to circulation tank 130. As mentioned earlier, the slow drain rate of rinse water from container 26a provides the novel controlled rate drying of this invention.

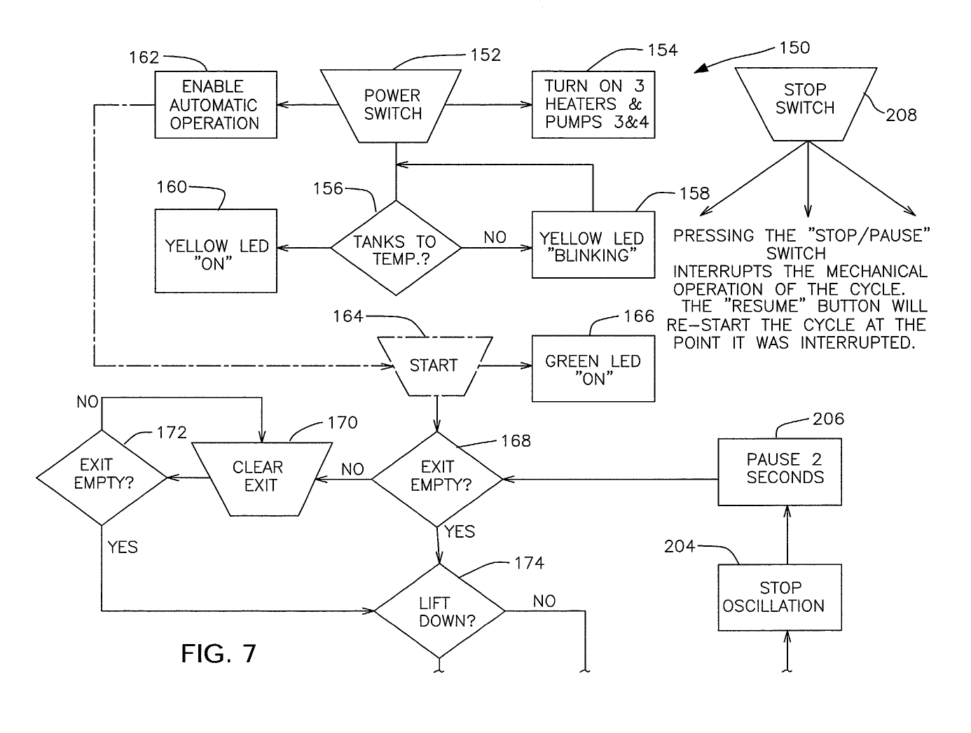

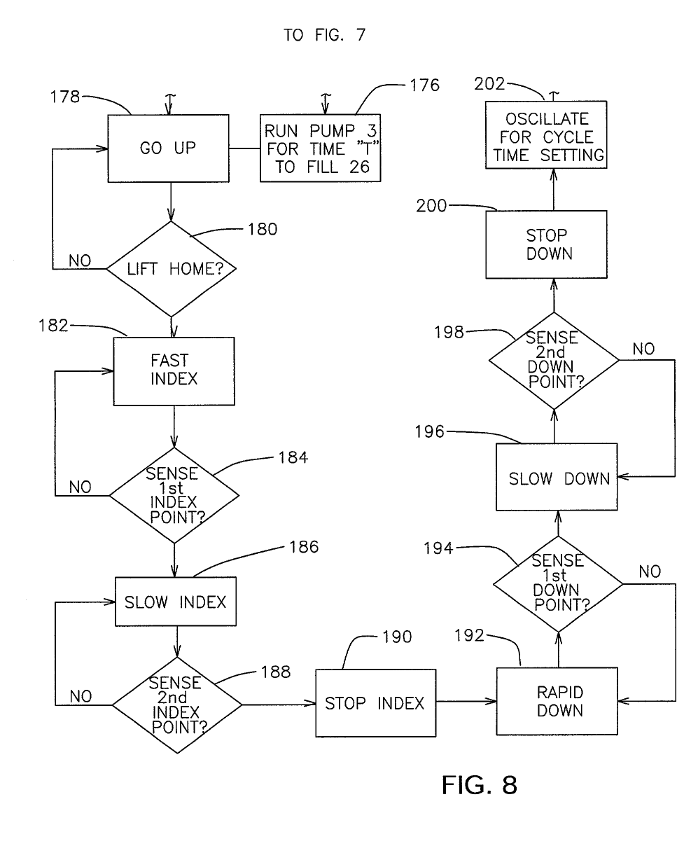

The sequence of operation of the novel apparatus will perhaps be better understood by making reference to FIG. 7, where a high level flowchart is denoted as a whole by the reference numeral 150. When a machine operator activates power switch 152, the microprocessor activates the heaters for stations 18, 20, and 26 and the circulation pumps 132, 134 as indicated by function block 154. A temperature sensor in each container 18a, 20a, and 26a sends a temperature-indicating signal to the microprocessor and the microprocessor decides, as indicated by decision block 156, if the temperature has reached a minimum acceptable threshold. If the temperature has not reached said minimum threshold, a signal is sent to yellow LED 210 on face panel 19 that causes said yellow LED to blink, as indicated by function block 158. If the temperature has reached the acceptable threshold, a signal activates the steady state illumination of yellow LED 210 as indicated by function block 160.

Upon detecting activation of the power switch, the microprocessor also sends a signal to enable automatic operation of the machine, as indicated by function block 162. As mentioned earlier, this enables the operator to start the machine without waiting for the liquid in the respective containers to heat up.

When the operator presses Start/Resume switch 164, the microprocessor sends a signal that illuminates green LED 166, as indicated by function block 166. The flow of the program then causes the microprocessor to decide whether or not discharge or exit station 28 is empty, as indicated by decision block 168. If it is not empty, the microprocessor waits until workpiece holder 88 is removed from discharge station 28 as indicated by function block 170 and decision block 172. If station 28 is still not empty, the program flows back to decision block 172. If a “Yes” is encountered, the microprocessor then decides, as indicated by decision block 174, whether or not the workpiece holder 88 is in its “Down” position. If it is not, pump 136 (associated with rinse/dry station 26) is operated for a predetermined amount of time, as indicated by function block 176, to fill container 26a and to circulate water therethrough as above-described.

If workpiece holder 88 is down, the microprocessor sends a signal to drive motor 38 to raise sleeve 32 and hence workpiece holder 88 and to operate pump 136 for a predetermined period of time. This action is indicated in the flow chart by function block 178. The microprocessor decides, as indicated by decision block 180, whether or not the cradle assembly is fully lifted and if it is not, the program flows along a “No” path and returns to function block 178. If the cradle assembly is determined to be fully raised, the microprocessor sends a “Fast Index” signal to index motor 58 and control disc 50, and hence central hub 68 rotates at its full speed to move each cradle assembly to the next station. This function is indicated by function box 182 in FIG. 6. The microprocessor then begins waiting for a signal from photoelectric cell 96 indicating that the leading edge of a notch 98 has been detected. If no such signal is received, the microprocessor decides that no leading edge has been detected and the “Fast Index” signal to index motor 58 is maintained. However, if the decision is made that the leading edge of a notch has been detected, the microprocessor sends a “Slow Index” signal to index motor 58 so that said motor begins operating at less than half speed. The decision as to whether or not the leading edge of a notch has been detected is represented in FIG. 6 by decision block 184. The sending of the “Slow Index” signal to index motor 58 is represented in said figure by function block 186.

After the leading edge of a notch has been detected, the microprocessor then begins waiting for a signal from the photocell that a trailing edge of a notch has been detected. The decision as to whether or not the trailing edge has been detected is represented by decision block 188. If the trailing edge has not been detected, the program flows along a “No” path and returns to function block 186. However, if the signal from the photocell is received, the microprocessor generates a “Stop Index” signal and index motor 58 is deactivated so that there is no further rotation of central hub 50 and its associated parts until the next start signal is received. The stop function is indicated by function block 190.

When index motor 58 has been deactivated by the microprocessor, the microprocessor than sends a “Rapid Down” signal to drive motor 38, as indicated by function block 192. As sleeve 32 descends rapidly, the microprocessor waits for a signal from the limit switch near the lowermost seat of lead screw 30, as indicated by decision block 194. If no signal is received, the program returns along a “No” path to function block 192 and the microprocessor continues to wait for the signal from said limit switch. If the signal from the limit switch near the lowermost end of the lead screw is received, the microprocessor sends a “Slow Down” signal to drive motor 38, as indicated by function block 196, and the vertical motion of the sleeve is reduced to les than half. The microprocessor then waits for a signal from the limit switch positioned at the lowermost seat of the lead screw, as indicated by decision block 198. If no signal is received, the program returns along a “No” path to function block 196 and the microprocessor continues to wait for the signal from said limit switch. If the signal from the limit switch at the lowermost seat of lead screw 30 is received, the microprocessor sends a “Stop” signal to drive motor 38, as indicated by function block 200, and the vertical motion of sleeve 32 is terminated. The slowdown prior to stopping lessens the shock of stopping and greatly improves vertical position accuracy as mentioned above.

When the “Stop” signal has been sent to drive motor 38, the microprocessor also sends a “Start” signal to oscillation motor 100 as indicated by function block 202. Oscillation motor 100 is under the control of the microprocessor and operates for a predetermined period of time. The molds or other items being cleaned are agitated by the oscillations, thereby affecting the effectiveness of the solvent, surfactant, and rinse water at stations 18, 20, 22, and 24, respectively. At the end of the predetermined period of time, the microprocessor sends a “Stop“ signal to oscillation motor 100, as indicated by function block 204. The microprocessor then sends a “Pause” signal to motors 38 and 58 as indicated by function block 206. The pause period may be a couple of seconds or any other time period as determined by the programming of the microprocessor.

The pause period is intended to allow the oscillator/agitator means to come to a complete stop. The program flows to decision block 168 and the cycle as described above is again repeated.

As indicated by the diagrammatic representation of Stop/Pause switch 208, the mechanical operation of the machine is stopped anytime said button is pressed. Pressing Stop/Pause button 208 restarts the cycle at the same point at which it was stopped.

If the system malfunctions at any point of the cycle, an audible alarm signals the precise reason for the malfunction. For example, a single buzzing or beeping sound could indicate a problem with the first solvent container, two of such sounds could indicate a problem with the second solvent/surfactant container, and so on.

If any moving part of the machine jams for any reason, such as encountering a resistance to movement caused by an operator”s hand, the microprocessor immediately deactivates the machine. Current sensors (not shown), associated with each of the three motors, send a “Current Overload” signal to the microprocessor whenever a current overload condition is detected. The microprocessor then sends a “Stop” signal to all of said motors. The operator can also activate Stop/Pause switch 208 when needed.

It will thus be seen that the objects set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention that, as a matter of language, might be said to fall therebetween.

Now that the invention has been described,

1. An apparatus for cleaning and drying items, comprising:
a plurality of stations including a loading station adapted to receive items to be cleaned, a first cleaning station, a first rinse station, and a final rinse and drying station arranged in circumferentially spaced apart relation to one another;
a rotatably mounted central hub positioned in encircled relation to said plurality of stations;
a plurality of radially disposed arm members having respective radially innermost ends connected to said central hub;
a plurality of workpiece holders, each of which is adapted to hold an item to be cleaned and dried, each of which is secured to a radially outermost end of said arm members, and each of which depends from an associated radially outermost end of a radially disposed arm member;
lifting and lowering means for lifting and lowering said workpiece holders;
indexing means for effecting rotation of said central hub about a vertical axis in accordance with a predetermined program of operation; and
a microprocessor means for controlling operation of said lifting and lowering means and said indexing means.

2. The apparatus of claim 1, wherein said first cleaning station further includes:
a solvent container means adapted to hold a predetermined quantity of a solvent;
a heater means for heating said solvent to a predetermined temperature;
a drain means that enables draining of said solvent from said solvent container means;
said heater means being under the control of said microprocessor.

3. The apparatus of claim 1, wherein said first rinse station further includes:
a first rinse water container means adapted to hold a predetermined quantity of rinse water;
a circulation tank of rinse water in fluid communication with rinse water in said first rinse water container means;
a filter disposed in said circulation tank;
a circulation pump adapted to circulate water between said circulation tank and said first rinse water container means;
said filter disposed in fluid communication with an inlet of said circulation pump so that only filtered water is pumped into said first rinse water container means;
a weir means formed in said first rinse water container means just below an upper rim thereof for skimming off surface contamination;
whereby said circulation pump pumps filtered water from said circulation tank into said first rinse water container means; and
whereby rinse water from said first rinse water container means flows over said weir means into said circulation tank so that rinse water in said first rinse water container means is continuously filtered and re-used.

4. The apparatus of claim 1, further comprising:
an oscillation means for oscillating a workpiece holder holding an item to be cleaned in said first solvent container means to enhance the cleaning action of said solvent;
said oscillation means including an oscillation motor under the control of said microprocessor.

5. The apparatus of claim 1, further comprising:
an oscillation means for oscillating a workpiece holder holding an item to be cleaned in said rinse first water container means to enhance the rinsing action of said rinse water;
said oscillation means including an oscillation motor under the control of said microprocessor.

6. The apparatus of claim 1, wherein said lifting and lowering means further includes:
an upstanding lead screw;
an internally threaded sleeve screwthreadedly engaged to said lead screw; and
a reversible motor, under the control of said microprocessor, for rotating said lead screw in a first direction to cause lifting of said sleeve to an uppermost position and in a second direction to cause lowering of said sleeve to a lowermost position;
said central hub being lifted and lowered conjointly with said sleeve.

7. The apparatus of claim 6, further comprising:
a first limit switch means mounted near an uppermost end of said lead screw;
a trailing end of said sleeve actuating said first limit switch when a trailing end of said sleeve reaches said first limit switch means;
said first limit switch means adapted to send a signal to said microprocessor when said first limit switch is actuated;
said microprocessor adapted to send a “Slow Down” signal to said reversible motor upon receipt of said signal from said first limit switch means;
whereby said sleeve slows down as it approaches said uppermost position.

8. The apparatus of claim 7, further comprising:
a second limit switch means mounted near a lowermost end of said lead screw;
a trailing end of said sleeve actuating said second limit switch means when a trailing end of said sleeve reaches said second limit switch means;
said second limit switch means adapted to send a signal to said microprocessor when said second limit switch is actuated;
said microprocessor adapted to send a “Slow Down” signal to said reversible motor upon receipt of said signal from said second limit switch means;
whereby said sleeve slows down as it approaches said lowermost position.

9. The apparatus of claim 1, wherein said indexing means further includes:
an indexing motor under the control of said microprocessor;
a rotatably mounted control disc connected in driven relation to said indexing motor;
said control disc having a plurality of circumferentially and equidistantly spaced notches formed therein;
a photoelectric cell means for detecting a leading edge and a trailing edge of each notch;
said microprocessor causing said indexing motor to reduce its speed when a leading edge is detected and to stop when a trailing edge is detected;
whereby a rotatable position of said control disc and hence said central hub is controlled with precision by said microprocessor to ensure alignment between said items being cleaned and their respective containers.

10. The apparatus of claim 1, further comprising:
a second cleaning station circumferentially disposed between said first cleaning station and said first rinse station;
a second rinse station circumferentially disposed between said first rinse station and said drying station; and
a discharge station where cleaned items are retrieved from said apparatus, said discharge station being circumferentially disposed between said drying station and said loading station.

11. The apparatus of claim 10, wherein said second cleaning station further includes:
a surfactant container means adapted to hold a predetermined quantity of a predetermined solution;
a heater means for heating said predetermined solution to a predetermined temperature;
a drain means that enables draining of said predetermined solution from said surfactant container means;
said heater means being under the control of said microprocessor.

12. The apparatus of claim 11, wherein said predetermined solution is a solvent.

13. The apparatus of claim 11, wherein said predetermined solution is a surfactant.

14. The apparatus of claim 11, wherein said predetermined solution is a mixture of a solvent and a surfactant.

15. The apparatus of claim 10, further comprising:
an oscillation means for oscillating a first workpiece holder adapted to hold an item to be cleaned in said first solvent container means, a second workpiece holder adapted to hold an item to be cleaned in said second solvent container means, a third workpiece holder adapted to hold an item in said first rinse water container means, and a fourth workpiece holder adapted to hold an item in said second rinse water container means, to enhance the cleaning action of said solvent and said surfactant, respectively, and to enhance the rinsing action of said rinse water;
said oscillation means including an oscillation motor under the control of said microprocessor.

16. The apparatus of claim 1, further comprising:
means for draining rinse water from said final rinse and drying station at a rate sufficiently slow to maintain the surface tension of the rinse water intact as the level of rinse water within said final rinse and drying station is reduced;
whereby the surface tension dries the molds by pulling the rinse water from the molds as the rinse water drains, leaving no patches of water behind; and
whereby said slow rate of draining prevents formation of water spots.

17. The apparatus of claim 1, further comprising:
deactivating means for deactivating the apparatus if any moving part of said apparatus encounters a resistance to movement that is above a preselected threshold.

18. The apparatus of claim 17, wherein said apparatus includes a first motor means for rotating said rotatably mounted central hub, a second motor means for lifting and lowering said workpiece holders, and a third motor means for oscillating said item to be cleaned, said deactivating means including a sensor associated with each of said motor means, said sensor adapted to send an overload signal to a microprocessor if an overload condition is detected, and said microprocessor adapted to send a “Stop” signal to a particular motor means upon receipt of an overload signal from that particular motor means.
